(19) United States
(12) Patent Application Publication
(10) Pub. No.: US 2007/0151165 A1
(43) Pub. Date: Jul. 5, 2007

(54) Door sill restrictor

(76) Inventor: Al Brendel, Clearwater, FL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/643,538

(22) Filed: Dec. 21, 2006

Related U.S. Application Data
(60) Provisional application No. 60/755,952, filed on Jan. 3, 2006.

(51) Int. Cl. E06B 1/70

(52) U.S. Cl. 49/467

(57) ABSTRACT

A door sill restrictor for preventing the entry of foreign matter such as water and airborne particulates into a building is shown and described. The door sill restrictor is one selected from a foam member and a sponge member. In one exemplary door assembly, the door sill restrictor is disposed in a space defined by a door and the sill.

### CROSS REFERENCE TO RELATED APPLICATIONS

This application claims the benefit of U.S. provisional application 60/755,952 filed on Jan. 3, 2006, the entirety of which is hereby incorporated herein by reference.

### TECHNICAL FIELD

Door sill restrictors for preventing the entry of foreign matter into buildings are disclosed and described, more specifically, restrictors comprised of water absorbent materials that reduce or prevent the penetration of water or airborne particulates through sliding door assemblies are disclosed and described.

### BACKGROUND

Many sliding doors are mounted in an elevated sill that includes a water retaining pocket on the inside of the sliding door. During periods of rain, water is drawn under the doors and fills the pocket due to pressure differences that exist between the inside and outside of the doors. As the pocket fills, a hydrostatic head is created which may reduce the further penetration of water. At equilibrium, the hydrostatic head pressure is equal to the pressure difference across the door (neglecting head changes due to capillary action).

Unfortunately, buildings are not perfectly sealed structures. They continuously experience gains or losses of air to the outside through vents, door seals, window seals, and other miscellaneous openings. If a building is subjected to high winds, a pressure differential will be created across the upwind and downwind sides of the building. This pressure differential will cause air to be sucked into the upwind side of the building and forced out of the downwind side of the building. If water is present outside the door, it is drawn under the door and accumulates in the sill pocket. Air is also drawn into the sill pocket and can create a turbulent bubbling or percolating effect which causes accumulated water to splash over the top of the sill and into the building. As water is splashed out of the sill, more water is drawn in to equalize the pressures across the door, which can lead to significant flooding and water damage.

Without the presence of water, air bearing dust and dirt particles are also drawn under the doors. This dust and dirt are drawn into the dwelling by the vacuum created by the pressure differential on the upwind and downwind sides of the building. As a result, a need has arisen for a door sill restrictor that addresses the foregoing issues.

### SUMMARY

A door assembly comprises a door mounted on a sill. The sill and the door define a space. A door sill restrictor is disposed in the space and preferably comprises a porous, flexible, compressible structure such as a cellular foam or a sponge material. In one embodiment, the door sill restrictor has an open cell structure. In another embodiment, the door sill restrictor is an open cell polyurethane foam. In yet another embodiment, the space is beneath the door. In still another embodiment, the door assembly is mounted in a building and the pocket is located in the interior of the building. In a further embodiment, the space has a width and the door sill restrictor substantially conforms to the width. In still another embodiment, the sill has a height and the door sill restrictor has a height that is less than the sill height.

In another embodiment, a door sill restrictor for preventing the entry of foreign matter into a building having an interior and an exterior is provided. The building has a door separating the interior of the building from the exterior of the building. The door is disposed in a door sill such that the door and the door sill define a pocket located in the interior of the building. The door sill restrictor is disposed in the pocket, and the door sill restrictor comprises one selected from a foam member and a sponge member.

In a further embodiment, a door assembly for restricting the entry of foreign matter into a building having an interior and an exterior is provided. The door assembly comprises a first door adjacent a second door. The first door and the second door are disposed in a door sill. At least of one the first door and the second door is movable relative to the other of the first door and the second door. The first door and the door sill define a first pocket located in the interior of the building, and the second door and the door sill define a second pocket located in the interior of the building. A first door sill restrictor is disposed in the first pocket, and a second door sill restrictor is disposed in the second pocket. The first door sill restrictor consists of one selected from a foam member and a sponge member, and the second door sill restrictor consists of one selected from a foam member and a sponge member.

In an additional embodiment, a door assembly for restricting the entry of foreign matter into a building comprises a door having a bottom surface defining a channel therein. A door sill restrictor comprising one selected from a foam member and a sponge member is disposed in the channel such that the door is movable relative to the door sill restrictor.

### BRIEF DESCRIPTION OF THE DRAWINGS

Embodiments will now be described by way of example in greater detail with reference to the attached figures, in which:

FIG. 1 is a perspective view of an embodiment of a door assembly depicting accumulated water in a door sill pocket;

FIG. 2 is a perspective view of the door assembly of FIG. 1 which includes an embodiment of a door sill restrictor;

FIG. 3 is a perspective view of a first alternate embodiment of a door assembly including two door sill restrictors; and

FIG. 4 is a side elevational view of a second alternative embodiment of a door assembly including a door sill restrictor.

### DETAILED DESCRIPTION

Referring to FIG. 1, a door assembly 10 is illustrated. Door assembly 10 includes a frame 20 comprising a sill 22. Door 24 is mounted in frame 20 and includes a groove (not shown) which slidingly engages rail 26 along the bottom of sill 22.

Sill 22 and door 24 define a space or pocket 23, which is preferably located on the interior of the building in which door assembly 10 is located. Pocket 23 creates a hydrostatic restrictor during periods of rain which is intended to reduce the penetration of water.

In FIG. 1, P2 represents the atmospheric pressure on the outside of door 24, and P1 represents the atmospheric pressure on the inside of door 24. When door 24 is closed, a pressure imbalance between the inside and outside of door 24 may be created. As a result, during a rain storm, water is drawn under door 24 and fills pocket 23. Assuming that no capillary forces exist between the water and the sill, at equilibrium the level of water, h, in pocket 23 will define a hydrostatic head pressure which equals the difference between P2 and P1:

P2−P1=ρ×g×h

Where ρ is the density of water and g is the acceleration due to gravity (9.8 m/sec² or 32 ft/sec² at sea level).

During storm conditions, high winds may create significant and variable differences in the pressures on the upwind and downwind side of the building in which door assembly 10 is installed. As a result, air may be drawn through water accumulated in pocket 23, causing it to splash over the top of sill 22. As more water is drawn under door 24 to replace the splashed water, the amount of water penetrating the building can become significant.

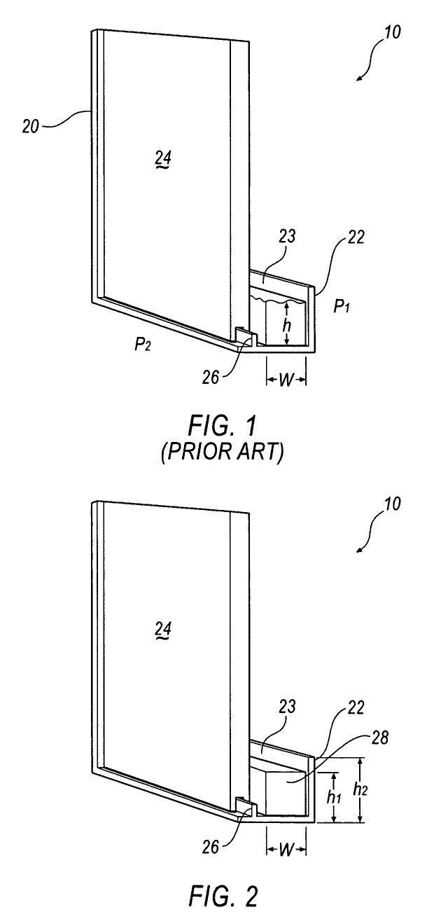

Referring to FIG. 2, a modified version of the door assembly of FIG. 1 is illustrated. Unlike FIG. 1, the door assembly 10 of FIG. 2 includes a door sill restrictor 28. Door sill restrictor 28 preferably restricts the entry of foreign matter, including but not limited to water and airborne particulates, into a building in which door assembly 10 is installed. In the embodiment of FIG. 2, door sill restrictor 28 is located on the inside of door 24, in the space or pocket 23 defined between door 24 and sill 22. Door sill restrictor 28 is preferably constructed from a water absorbent material that provides “wicking” or capillary action. As a result, water absorbed by restrictor 28 will rise along the height of restrictor 28, notwithstanding whether there is a pressure difference P2−P1 across door 24. The matrix of absorbed water and restrictor 28 provides additional pressure drop, which reduces the flow rate and/or turbulence of air flowing through sill 22, thereby reducing or eliminating the splashing of water over sill 22.

Door sill restrictor 28 is preferably permeable to air so it can readily deform to the shape of pocket 23 and provide a good seal between door 24 and sill 22. Preferred door sill restrictor materials include foams and sponges, more preferably, foams and sponges having open cell structures which are substantially conformable to the shape of pocket 23. Preferably, the foams also remain flexible and conformable in their “dry” state so they can be easily inserted or removed when not required.

The term “foam” refers generally to dispersions of gas bubbles in a solid. The gas bubbles (typically air) define cells within the foam. In certain foams, the cells are not open or otherwise in fluid communication with one another. These foams are referred to as “closed cell” foams. However, in other foams, the cells are open to one another, and gases such as air may move freely between cells. These foams are known as “open cell” foams. Because of their open nature, open cell foams more readily admit and expel air, giving them improved compressibility and deformability in comparison to closed cell foams. They also allow absorbed water to readily evaporate, avoiding the need for wringing them out and decreasing the build up of mold.

A variety of foam compositions may be used for door sill restrictor 28. However, polyurethane foams are preferred. In addition, restrictor 28 is preferably flexible and dimensionally stable when wet or dry. It also preferably maintains its structural integrity when exposed to hot or cold temperatures. In addition, preferred door sill restrictor materials will remove and/or reduce the entry of at least some amount of airborne particulates, providing a generally cleaner environment in the interior of the building in which door assembly 10 is mounted. In one exemplary embodiment, door sill restrictor 28 is constructed from AQUAZONE®, a polyurethane foam manufactured by Foamex, L.P. and distributed by Reilly Foam Corp. of West Palm Beach, Fla.

Known foams are typically characterized by their pore density in pores per linear inch or “ppi.” If a foam contains too many pores, it will not restrict the flow of air sufficiently to prevent splashing. However, if a foam contains too few pores, it will not allow air to pass through it and will not be sufficiently compressible to form a tight seal with sill 22 and door 24. Preferred pore densities range from about 60 to about 100 ppi, with pore densities of from about 70 to about 90 ppi being more preferred. A pore density of about 80 ppi is especially preferred. In one exemplary embodiment, an 80 ppi AQUAZONE® foam is used for door sill restrictor 28.

Referring again to FIG. 2, door sill restrictor 28 preferably has a width w, which provides for a generally tight seal between door 24 and sill 22. A tight seal minimizes the likelihood that pockets of water will form within pocket 23 and outside of restrictor 28. In addition, door sill restrictor 28, preferably has a height h1, which is less than the height h2 of sill 22 to minimize the likelihood that absorbed water will leak over the top of sill 22. In general, the specific dimensions of door sill restrictor 28 will depend on the dimensions of pocket 23. However, in one exemplary embodiment, restrictor 28 has a width of about 2½ inches, a height of about 2 inches, and a length of about 48 inches. In another exemplary embodiment, restrictor 28 has a width of about 1½ inches, a height of about 1 inch, and a length of about 48 inches.

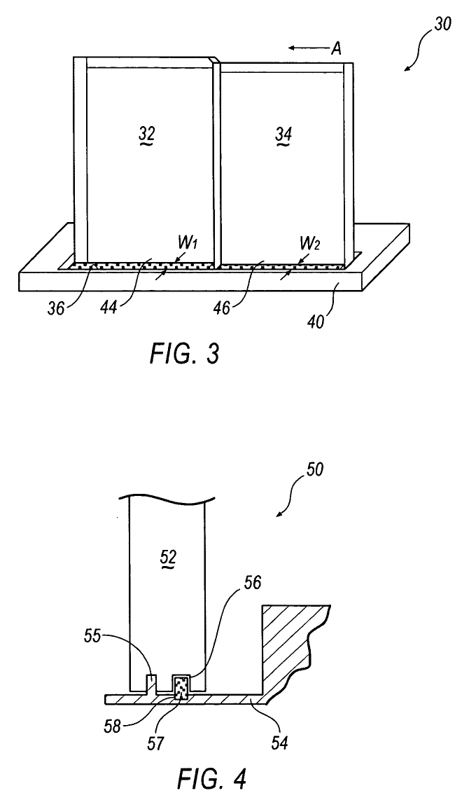

In typical sliding door assemblies, both a sliding door and a stationary door are provided. Referring to FIG. 3, a perspective view of an alternate embodiment of a door assembly 30 is illustrated. Door assembly 30 is viewed from the inside of the building in which it is mounted. Door 34 is slidably mounted in sill 40 (the remainder of the frame is not shown) and is movable in the indicated direction “A.” Door 32 remains fixed in position. Door assembly 30 has a closed position (illustrated in FIG. 3), in which the opening defined by the door frame is occupied by doors 32 and 34. Door assembly 30 also has an open position in which door 34 is slid in the direction “A” (shown in the figure) such that it is partially or completely in front of door 32 when viewed from the building interior.

In door assembly 30, two door sill restrictors, 44 and 46, are provided. Like door sill restrictor 28 in FIG. 2, door sill restrictor 44 is positioned on the inside of door 32 in an interior pocket between the back wall 36 of sill 40 and door 32. Door sill restrictor 46 is similarly placed in an interior pocket between the inside of door 34 and back wall 36 of sill 40. Because of its location, restrictor 44 will impede or prevent the opening of door 34. As a result, door 32 can only be opened by removing restrictor 44.

In FIG. 3, fixed door 32 is placed slightly forward (toward the building exterior) of sliding door 34. Thus, the interior pocket defined by door 32 and sill 40 is larger than the interior pocket defined by door 34 and sill 40. As a result, door sill restrictor 44 has a width w1 that is greater than the width w2 of door sill restrictor 46.

As the height to width ratio of the restrictors increases, it may become increasingly difficult to insert them into sill 50. To facilitate their insertion into sill 40, it may be desirable to size them with a generally square cross section. Thus, in an exemplary embodiment, restrictor 44 has a height of 2 inches and a width of about 2½ inches, while restrictor 46 has a height of about 1 inch and a width of about 1½ inches.

A method of using the door assembly of FIG. 3, will now be described. Because of the positioning of the restrictors in the clearance areas of the doors, they must be removed to allow the doors to operate normally. However, doors designed with restrictors under the door (see FIG. 4) can be made to allow the restrictors to remain in place continuously.

In accordance with the method, door sill restrictors 44 and 46 are preferably inserted prior to or during a heavy rain storm, during a period of high winds, or during a period of time where the building in which they are used will not be occupied. Restrictor 46 is inserted into sill 40 in an interior pocket defined by sill 40 and door 34. Restrictor 44 is inserted into sill 40 in an interior pocket defined by sill 40 and door 32. To provide a good seal and insure that absorbed water does not leak over sill 40, both restrictors 44 and 46 are preferably dimensioned and inserted to fit snugly within their respective pockets and so they do not project above the sill.

The use of door sill restrictors 44 and 46 in this manner decreases the amount of water entering underneath doors 32 and 34. It also preferably filters airborne particulates from air entering the building in which doors 32 and 34 are mounted. Door sill restrictors 44 and 46 preferably comprise a material that can be washed, or more preferably machine washed, while retaining their dimensional stability and integrity. Thus, after a period of extended use, restrictors 44 and 46 are preferably washed to remove any accumulated dirt or airborne particulates.

Referring to FIG. 4, a second alternate embodiment of a door assembly is provided. Door assembly 50 comprises a door 52 (a portion of which is shown in the figure) and a sill 54. Sill 54 includes a rail 55 which slidingly engages a complementary groove (not shown) formed in door 52 to allow it to open and close.

In this alternate embodiment, door 52 includes a channel or groove 56 in which door sill restrictor 57 is inserted. Door sill restrictor 57 is preferably stationary and configured to allow door 52 to move over it. Thus, in this embodiment, restrictor 57 can remain in place while allowing door 52 to be freely opened and closed. Door sill restrictor 57 is preferably on open cell foam of the type described above with respect to the embodiment of FIG. 2. To facilitate cleaning or replacement of restrictor 57, it may also be desirable to configure groove 56 so restrictor 57 is removably attachable to it.

While the invention has been described with respect to specific examples including preferred modes of carrying out the invention, those skilled in the art will appreciate that there are numerous variations and permutations of the above described systems and techniques that fall within the spirit and scope of the invention. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A door sill restrictor for preventing the entry of foreign matter into a building having an interior and an exterior, wherein the building has a door separating the interior of the building from the exterior of the building, and the door is disposed in a door sill such that the door and the door sill define a pocket located in the interior of the building, the door sill restrictor is disposed in the pocket, and the door sill restrictor is selected from the group consisting of a foam member and a sponge member.

2. The door sill restrictor of claim 1, wherein the door sill restrictor comprises a polyurethane foam.

3. The door sill restrictor of claim 1, wherein the pocket has a height, the door sill restrictor has a height, and the height of the door sill restrictor is less than the height of the pocket.

4. The door sill restrictor of claim 1, wherein the door sill restrictor has an open cell structure.

5. The door sill restrictor of claim 1, wherein the door sill restrictor has a pore density of from about 60 pores per linear inch to about 100 pores per linear inch.

6. A method of reducing the entry of foreign matter into a building, wherein the building has an interior, an exterior, a door sill, a door disposed in the door sill such that the door separates the interior of the building from the exterior of the building, and the door and the door sill define a pocket located in the interior of the building, the method comprising:
inserting the door sill restrictor of claim 1 in the pocket.

7. The method of claim 6, wherein the foreign matter comprises water.

8. The method of claim 6, wherein the foreign matter comprises airborne particulates.

9. The method of claim 6, wherein the door sill restrictor comprises a polyurethane foam.

10. The method of claim 6, wherein the door sill restrictor has an open cell structure.

11. The method of claim 6, wherein the door sill restrictor has a pore density of from about 60 pores per linear inch to about 100 pores per linear inch.

12. The method of claim 6, wherein the door sill restrictor has a height, the pocket has a height, and the height of the door sill restrictor is less than the height of the pocket.

13. A door assembly for restricting the entry of foreign matter into a building having an interior and an exterior, the door assembly comprising:
a first door adjacent a second door, wherein the first door and the second door are disposed in a door sill, at least one of the first door and the second door is movable with respect to the other of the first door and the second door, the first door and the door sill define a first pocket located in the interior of the building, and the second door and the door sill define a second pocket located in the interior of the building;
a first door sill restrictor disposed in the first pocket and a second door sill restrictor disposed in the second pocket, wherein the first door sill restrictor is selected from the group consisting of a foam member and a sponge member, and the second door sill restrictor is selected from the group consisting of a foam member and a sponge member.

14. The door assembly of claim 13, wherein the first door is movable with respect to the second door, the first pocket has a width, the second pocket has a width, the first pocket width is less than the second pocket width, the first door sill restrictor has a width, the second door sill restrictor has a width, and the first door sill restrictor width is less than the second door sill restrictor width.

15. The door assembly of claim 13, wherein at least one of the first door sill restrictor and the second door sill restrictor is a polyurethane foam.

16. The door assembly of claim 13, wherein at least one of the first door sill restrictor and the second door sill restrictor has an open cell structure.

17. A door assembly for restricting the entry of foreign matter into a building, the door assembly comprising:
a door having a bottom surface defining a channel therein; and
a door sill restrictor selected from the group consisting of a foam member and a sponge member, wherein the door sill restrictor is disposed in the channel such that the door is movable relative to the door sill restrictor.

18. The door assembly of claim 17, wherein the door sill restrictor comprises a polyurethane foam.

19. The door assembly of claim 17, wherein the door sill restrictor has an open-cell structure.

20. The door assembly of claim 17, wherein the foam member has a pore density of from about 60 pores per linear inch to about 100 pores per linear inch.
